(19) United States
(12) Patent Application Publication
(10) Pub. No.: US 2019/0159058 A1
(43) Pub. Date: May 23, 2019

(54) EXTENDED QUALITY OF SERVICE CLASS IDENTIFIER (QCI) MASKING

(71) Applicant: T-Mobile USA, Inc., Bellevue, WA (US)

(72) Inventor: Karunakalage Viraj Rakitha Silva, Renton, WA (US)

(21) Appl. No.: 16/141,380

(22) Filed: Sep. 25, 2018

Related U.S. Application Data
(60) Provisional application No. 62/589,445, filed on Nov. 21, 2017.

(51) Int. Cl. H04W 28/02; H04W 8/18; H04W 76/10

(52) U.S. Cl. CPC H04W 28/0268; H04W 76/10; H04W 8/18; H04W 28/0263

(57) ABSTRACT

Systems and methods for extended quality of service class identifier (QCI) masking are described. Subscriber accounts may be assigned an extended QCI value, which may be unsupported by a user device associated with the subscriber account. The communications network maintains a mapping between extended QCI values and standard QCI values. When a user device requests a new session with the communication network, the session may be established such that priority for the session within the communication network is based on the extended QCI value associated with the subscriber account, while the mapped standard QCI value is communicated to the user device in establishing the session.

### CROSS-REFERENCE TO RELATED APPLICATIONS

This application is a non-provisional application of, and claims priority to and the benefit of, U.S. Provisional Patent Application Ser. No. 62/589,445, filed Nov. 21, 2017, and entitled “Extended QCI Masking Toward Device,” the entirety of which is incorporated herein by reference.

### BACKGROUND

A quality of service (QoS) class identifier (QCI) is a scalar value that is used to prioritize services within a communication network. 3GPP 23.401 defines QCI values from 0 to 255. QCI values 1-9 are standardized, QCI values 10-127 are reserved, and QCI values 128-254 are defined as operator-specific QCIs. The extended QCI values (QCI values 10-254) enable a communication network to define specific priorities within the communication network. For example, a subscriber assigned a QCI value of 150 may be given a higher priority within the communication network than a subscriber assigned a QCI value of 200. While there may be significant value to utilizing extended QCI values within a communication network, many user devices are not configured to support the extended QCI values. For example, many mobile phones only recognize QCI values between 1 and 9. When a communication network attempts to use an extended QCI value when establishing a session with a user device that does not support the extended QCI value, errors may occur or the user device may crash.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 is a block diagram of an example communication network configured to implement extended quality of service (QoS) class identifier (QCI) masking.

FIG. 2 is a block diagram of an example communication network system configured to implement extended QCI masking.

FIG. 3 is a flow diagram of an example process for implementing extended QCI masking across multiple components of an example communication network.

FIG. 4 is a flow diagram of an example process for implementing extended QCI masking as performed by a mobility management entity of an example communication network.

### DETAILED DESCRIPTION

### Introduction

Systems and methods discussed herein are directed to extended quality of service (QoS) class identifier (QCI) masking.

A QCI is a scalar value that is used to prioritize services within a communication network. 3GPP 23.401 defines QCI values from 0 to 255. QCI values 1-9 are standardized, QCI values 10-127 are reserved, and QCI values 128-254 are defined as operator-specific QCIs. QCI values 1-9 are referred to herein as “standard QCI values,” while QCI values 10-254 are referred to herein as “extended QCI values.” The extended QCI values enable a communication network to define specific priorities within the communication network. For example, a subscriber assigned a QCI value of 150 may be given a higher priority within the communication network than a subscriber assigned a QCI value of 200. Any number of performance parameters associated with any number of network components may be associated with an extended QCI value. While there may be significant value to utilizing extended QCI values within a communication network, many user devices are not configured to support the extended QCI values. For example, many mobile phones only recognize QCI values between 1 and 9. When a communication network attempts to use an extended QCI value when establishing a session with a user device that does not support the extended QCI value, errors may occur or the user device may crash. By using an extended QCI value within the network system, but masking that value in communications to the device, the network is able to take full advantage of the extended QCI values and provide service priorities in accordance therewith. The user device (e.g., a mobile phone) is provided a standard QCI value, which masks (or hides) the extended QCI value that is being used on the network.

For example, a communication network provider may offer different service plans having different prices, and corresponding different levels of service. A first subscriber may pay a premium price for a premium service plan in which Internet data is given a higher priority over subscribers to a basic service plan. In this scenario, a mobile phone associated with the basic service plan and a mobile phone associated with the premium service plan may both be provided the same standard QCI value, however, the network associates different extended QCI values with the two sessions (or a standard QCI value with the session associated with the basic service plan and an extended QCI value with the session associated with the premium service plan). In this way, when processing Internet data for the two sessions, the network prioritizes the data for the session associated with the premium service plan over the data for the session associated with the basic service plan. There is no difference in how the mobile phones process the data based on QCI values, so providing both mobile devices with the same standard QCI values does not have a negative impact.

In the described example implementations, a communication session between a user device and a communication network may be established such that the communication network associates an extended QCI value with the session while communicating a standard QCI value to the user device. By mapping the extended QCI values to standard QCI values, the communication network is able to prioritize service based on the extended QCI value while masking the extended QCI value with a standard QCI value that is communicated to the user device. Communicating the standard QCI value to the user device prevents errors that may occur if the user device does not support extended QCI values.

### Example Network Environment

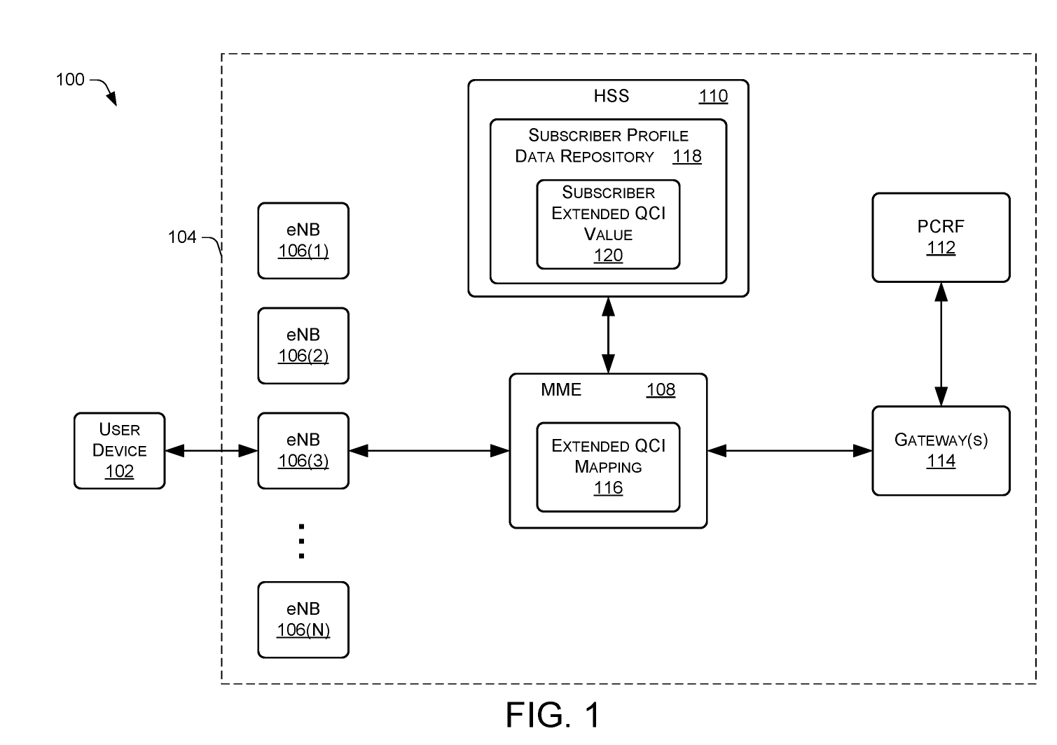

FIG. 1 illustrates an example network environment 100 in which extended QCI masking may be implemented. Example network environment 100 includes a user device 102 and a communication network 104. Communication network 104 includes any number of access points (evolved Node B (eNB)) 106(1), 106(2), 106(3), . . . , 106(N), a mobility management entity (MME) 108, a home subscriber server (HSS) 110, a policy and charging rules function (PCRF) 112, and one or more gateways 114. In the illustrated example, each component of the communication network 104 may be configured to support extended QCI values, and thus may be configured to prioritize service among active sessions based on extended QCI values associated with the active sessions. For example, each network component that supports extended QCI values may maintain priority data that defines, for each extended QCI value, one or more prioritization parameters, which are applied to a communication session having the particular extended QCI value.

Each eNB 106 is configured to enable communication between the user device 102 and the communication network 104. When a user device is powered on, the user device sends, and an eNB receives, a request to attach and activate a session with the communication network 104.

MME 108 is configured to perform authentication and authorization when a user device requests a new session with the communication network 104 and to perform session management. In the illustrated example, the MME 108 also maintains extended QCI mapping 116, which maps extended QCI values to standard QCI values. In the example described herein, extended QCI values may include values between 10 and 255, each of which may be mapped to a standard QCI value between 6 and 9. Standard QCI values 1-5 are standardized for specific types of data, while QCI values 6-9 provide more flexibility. Accordingly, in the example implementation described herein, each extended QCI value is mapped to a standard QCI value between 6 and 9.

HSS 110 is configured to maintain subscriber account information, which may include, for example, subscriber profile data, billing data, subscription data, and so on. In the illustrated example, subscriber profile data is maintained in a subscriber profile data repository 118 within the HSS 110. The subscriber profile data repository 118 may also include a subscriber extended QCI value 120, which is an extended QCI value that is associated with the subscriber account. Any number of business policies may be used to assign extended QCI values to subscriber accounts. As one example, a communication network 104 may offer a standard membership, a premium membership, and an economy membership, with the economy membership being less expensive and having a lower quality of service guarantee as compared to the standard membership, and the premium membership being more expensive and having a higher quality of service guarantee as compared to the standard membership. In this example, subscribers who subscribe to the standard membership may be assigned an extended QCI value of 200, subscribers who subscribe to the premium membership may be assigned an extended QCI value of 150, and subscribers who subscribe to the economy membership may be assigned an extended QCI value of 250.

Policy and charging rules function (PCRF) 112 is configured to apply and enforce various policies and rules with regard to each subscriber active on the communication network 104 at any given time.

Gateways 114 is representative of any number of serving gateways (SGW) and/or packet data network (PDN) gateways. Gateways 114 are configured to support transmission and receipt of various types of data associated with any number of active subscriber sessions within the communication network 104.

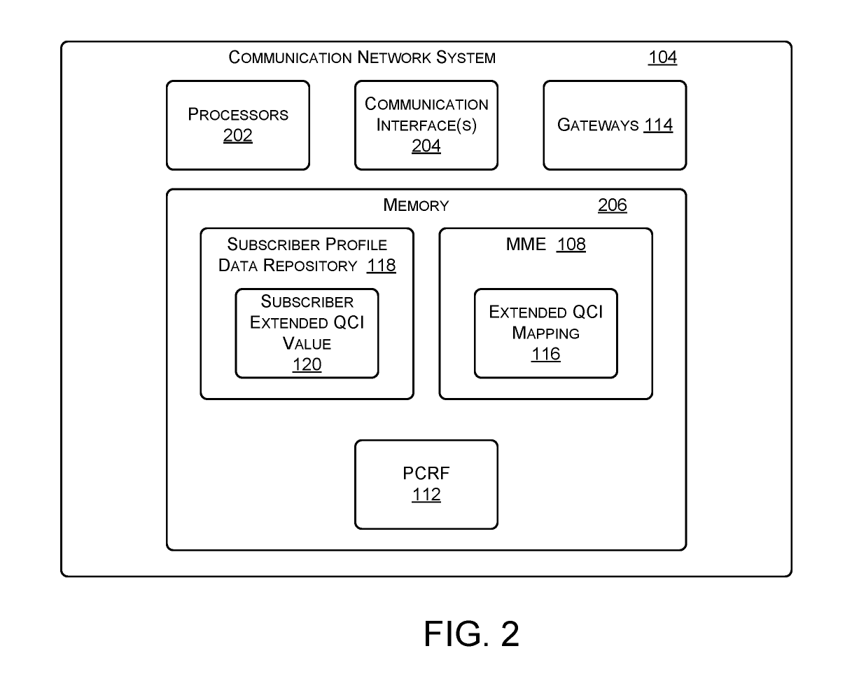

FIG. 2 illustrates select components of a communication network system 104 configured to implement extended QCI masking as described herein. Example communication network system 104 includes one or more processors 202, any number of communication interfaces 204, any number of gateways 114, and memory 206 communicatively coupled to the one or more processors 202. Memory 206 may include, for example, subscriber profile data repository 118, MME 108, and PCRF 112. Subscriber profile data repository 118 includes subscriber extended QCI value 120. MME 108 includes extended QCI mapping 116. In an alternate example implementation, the extended QCI mapping 116 may be maintained in the subscriber profile data repository 118, such that, for example, the subscriber profile data repository 118 maintains, for an individual subscriber, both an extended QCI value and a standard QCI value.

Communication interfaces 204 enable communication between components of the communication network system 104 and communication between the communication network system 104 and other devices (e.g., user devices).

Subscriber profile data repository 118 maintains user profile data for user devices associated with the communication network system 104. User profile data may include, for example, user name, phone number, user device ID, billing data, and so on. In addition, subscriber profile data repository includes subscriber extended QCI value 120, which specifies an extended QCI value associated with the user account.

MME 108 is configured to provide authentication and authorization, and to provide session management. In the illustrated example, the MME 108 also maintains the extended QCI mapping 116, which maps extended QCI values, which are associated with subscriber accounts, to standard QCI values, which are supported by user devices.

PCRF 112 is configured to apply and enforce various policies and rules with regard to each subscriber active on the communication network 104 at any given time.

### Example Processes

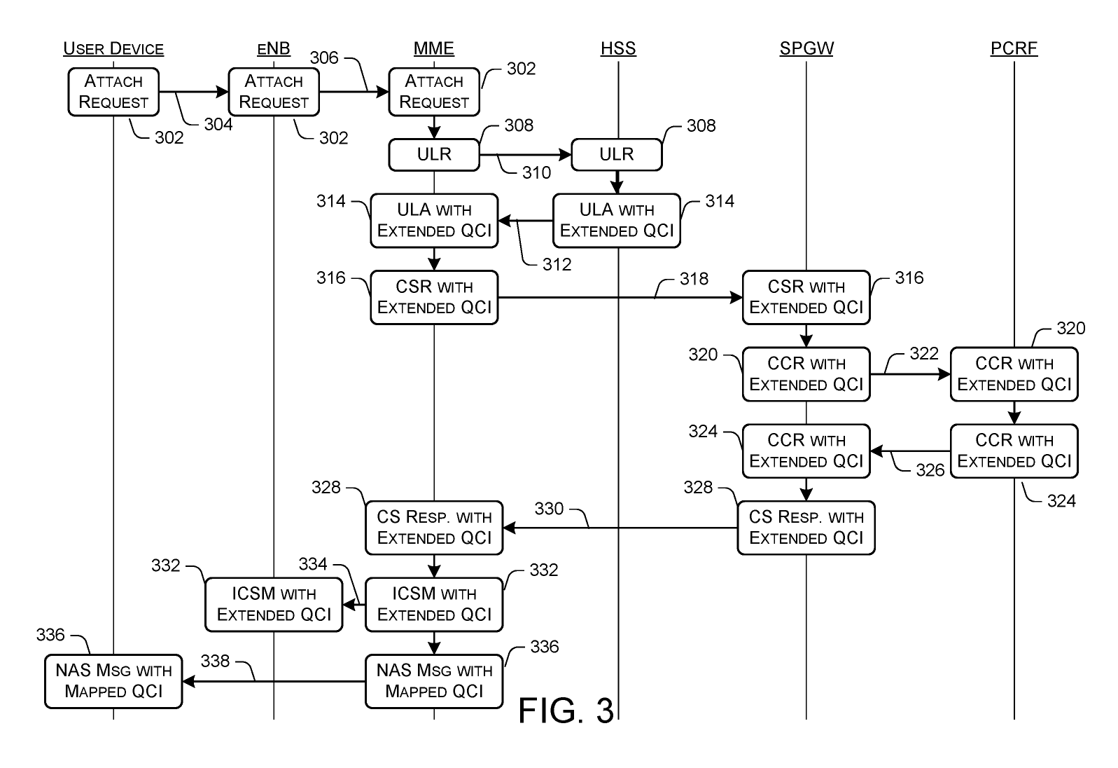

FIG. 3 is a flow diagram illustrating an example series of communications between components of the example environment illustrated in FIG. 1 to perform extended QCI masking.

When user device 102 is initially powered on, the user device 102 sends an attach request 302 to an eNB 106, as indicated by arrow 304. As indicated by arrow 306, the eNB 106 forwards the attach request 302 to the MME 108.

In response to receiving the attach request 302, the MME authorizes and authenticates the user device 102 by sending an update location request (ULR) 308 to the HSS 110, as indicated by arrow 310.

In response to receiving the ULR 308, the HSS 110 determines the extended QCI associated with the subscriber account indicated in the ULR 308. For example, the HSS 110 looks up the extended QCI value in the subscriber profile data repository 118. As indicated by arrow 312, the HSS 110 then returns to the MME 108 an update location answer (ULA) 314 that includes the subscriber's extended QCI value.

The MME 108 then sends a create session request (CSR) 316, with the subscriber's extended QCI value to the SPGW 114, as indicated by arrow 318.

In response to receiving the CSR 316, the SPGW 114 then sends a credit control request (CCR) 320 with the subscriber's extended QCI value to the PCRF 112, as indicated by arrow 322. In some examples, the PCRF 112 may then overwrite the extended QCI value, for example, if the extended QCI value assigned to the subscriber account has changed since it was last retrieved by the HSS 110.

The PCRF 112 then sends a CCR 324 to the SPGW 114, as indicated by arrow 326. CCR 324 includes the extended QCI value, which may have been updated by the PCRF 112.

The SPGW 114 then sends a create session response 328 that includes the extended QCI to the MME 108, as indicated by arrow 330.

In response to receiving the create session response 328, the MME 108 determines the standard QCI value to which the extended QCI value is mapped. For example, the MME 108 queries the extended QCI mapping 116 to determine a standard QCI value to which the extended QCI value is mapped. The MME 108 then sends an initial context setup message (ICSM) 332 to the Enb 106, as indicated by arrow 334, and sends a non-access stratum (NAS) message 336 (inside the initial context setup message) to the user device 102 with the mapped standard QCI value, as indicated by arrow 338.

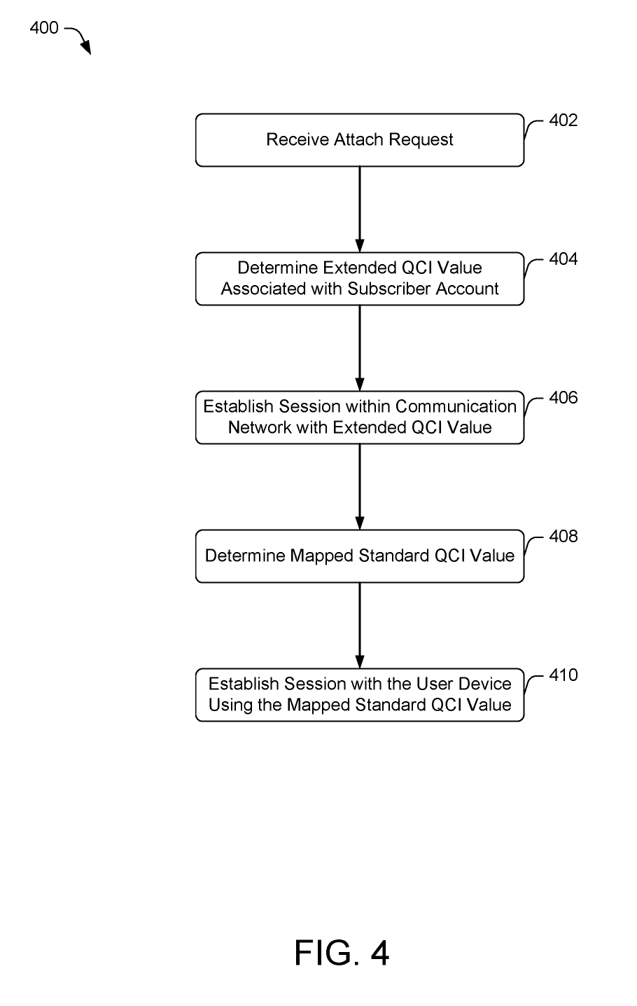

FIG. 4 is a flow chart of an example process 400 for implementing extended QCI masking.

At block 402, a request to attach to a communication network is received. For example MME 108 receives an attach request from a user device 102 via an eNB 106.

At block 404, an extended QCI value associated with the subscriber account is determined. For example, the MME 108 sends a ULR to the HSS 110, and the HSS 110 returns a ULA that includes the extended QCI associated with the subscriber account, as stored in the subscriber profile repository 118.

At block 406, a session is established within the communication network using the extended QCI value. For example, the MME 108 communicates the extended QCI value to the PCRF 112 and the gateways 114 to establish the session. The MME also sends the extended QCI value to the eNB 106.

At block 408, a mapped standard QCI value is determined. For example, the MME 108 identifies the extended QCI value in the extended QCI mapping 116 to determine the standard QCI value to which the extended QCI value is mapped.

At block 410, the session is established with the user device using the mapped standard QCI value. For example, the MME 108 sends to the user device 102, an NAS message that includes the standard QCI value.

Some or all operations of the processes described above can be performed by execution of computer-readable instructions stored on a computer storage medium, as defined below. The term “computer-readable instructions” as used in the description and claims, include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like. Memory 206 is an example of computer storage media.

The computer storage media may include volatile memory (such as random access memory (RAM)) and/or non-volatile memory (such as read-only memory (ROM), flash memory, etc.). The computer storage media may also include additional removable storage and/or non-removable storage including, but not limited to, flash memory, magnetic storage, optical storage, and/or tape storage that may provide non-volatile storage of computer-readable instructions, data structures, program modules, and the like.

A non-transient computer storage medium is an example of computer-readable media. Computer-readable media includes at least two types of computer-readable media, namely computer storage media and communications media. Computer storage media includes volatile and non-volatile, removable and non-removable media implemented in any process or technology for storage of information such as computer-readable instructions, data structures, program modules, or other data. Computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism. As defined herein, computer storage media do not include communication media.

The computer-readable instructions stored on one or more non-transitory computer storage media that, when executed by one or more processors, may perform operations described above with reference to FIGS. 1-4. Generally, computer-readable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method implemented at a communication network, the method comprising:
assigning, at the communication network, an extended quality of service (QoS) class identifier (QCI) to a subscriber account;
mapping, at the communication network, the extended QCI to a standard QCI;
receiving, at the communication network, a request from a user device to attach and activate a session;
determining the subscriber account is associated with the user device;
establishing a session between the user device and the communication network, wherein:
within the communication network, the session is associated with the extended QCI; and
within the user device, the session is associated with the standard QCI.

2. A method as recited in claim 1, wherein the extended QCI comprises a value between 128 and 254.

3. A method as recited in claim 1, wherein the extended QCI comprises a value between 10 and 254.

4. A method as recited in claim 1, wherein the standard QCI comprises a value between 6 and 9.

5. A method as recited in claim 1, further comprising within the communication network, prioritizing services to the user device based on the extended QCI.

6. A communication network comprising:
one or more processors;
memory, communicatively coupled to the one or more processors;
a mobility management entity stored in the memory and executed on the processor, the mobility management entity configured to:
maintain a mapping between extended quality of service (QoS) class identifier (QCI) values and standard QCI values;
receive, from a user device, a request to attach and activate a session with the communication network; and
in response to receiving the request:
determine an extended QCI value associated with a subscriber account associated with the user device;
determine a standard QCI value that is mapped to the extended QCI value associated with the subscriber account associated with the user device;
establish a session between the user device and the communication network, wherein:
within the communication network, the session is associated with the extended QCI value associated with the subscriber account associated with the user device; and
within the user device, the session is associated with the standard QCI value that is mapped to the extended QCI value associated with the subscriber account associated with the user device.

7. A communication network as recited in claim 6, wherein the extended QCI comprises a value between 128 and 254.

8. A communication network as recited in claim 6, wherein the extended QCI comprises a value between 10 and 254.

9. A communication network as recited in claim 6, wherein the standard QCI comprises a value between 6 and 9.

10. A communication network as recited in claim 6, further comprising a subscriber profile data repository that is configured to maintain an extended QCI value associated with the subscriber account.

11. One or more non-transitory computer storage media comprising computer-executable instructions that, when executed, direct a computing system to perform operations, the operations comprising:
receiving from a user device, a request to attach and activate a session with a communication network;
determining a subscriber account associated with the user device;
determining an extended quality of service class identifier (QCI) value associated with the subscriber account;
determining a standard QCI value that is mapped to the extended QCI value that is associated with the subscriber account; and
establishing a communication session between the user device and the communication network, wherein:
a message from the communication network to the user device includes the standard QCI value; and
components of the communication network prioritize service for the session based on the extended QCI value.

12. One or more non-transitory computer storage media as recited in claim 11, the operations further comprising authenticating and authorizing on the communication network, the subscriber account associated with the user device.

13. One or more non-transitory computer storage media as recited in claim 11, wherein determining the extended QCI value associated with the subscriber account comprises requesting the extended QCI value from a subscriber profile data repository.

14. One or more non-transitory computer storage media as recited in claim 11, wherein determining the standard QCI value that is mapped to the extended QCI value that is associate with the subscriber account comprises querying an extended QCI mapping that maintains a mapping between extended QCI values and standard QCI values.

15. One or more non-transitory computer storage media as recited in claim 11, wherein determining the standard QCI value that is mapped to the extended QCI value that is associate with the subscriber account comprises requesting the standard QCI value from a subscriber profile data repository.

16. One or more non-transitory computer storage media as recited in claim 11, wherein the extended QCI value comprises a value between 10 and 254.

17. One or more non-transitory computer storage media as recited in claim 11, wherein the extended QCI value comprises a value between 128 and 254.

18. One or more non-transitory computer storage media as recited in claim 11, wherein the standard QCI value comprises a value between 6 and 9.

19. One or more non-transitory computer storage media as recited in claim 11, the operations further comprising assigning an extended QCI value to the subscriber account.

20. One or more non-transitory computer storage media as recited in claim 11, the operations further comprising maintaining a mapping between extended QCI values and standard QCI values.
